(19) United States
(12) Patent Application Publication
(10) Pub. No.: US 2005/0164778 A1
(43) Pub. Date: Jul. 28, 2005

(54) Game die having electronic timer

(76) Inventor: Daniel J. Cooney, Newtown, PA (US)

Correspondence Address: Mr. Edward J. Timmer, P.O. Box 770, Richland, MI, 49083-0770, US

(21) Appl. No.: 11/039,078

(22) Filed: Jan. 20, 2005

Related U.S. Application Data
(60) Provisional application No. 60/540,037, filed on Jan. 28, 2004.

(51) Int. Cl. A63F 13/00

(52) U.S. Cl. 463/22

(57) ABSTRACT

A game die for use in playing games wherein the die includes a die body with multiple sides and wherein an electronic timer and a timer-responsive visual signal generating device and/or audio signal generating device is/are located on the body. A motion sensing device is disposed on the body to activate the timer to start timing when the die is used in playing the game.

This application claims benefits and priority of provisional application Ser. No. 60/540,037 filed Jan. 28, 2004.

### FIELD OF THE INVENTION

The present invention relates to dice used in playing a game and the like, and more particularly, to a game die having an internal electronic timer and one or more of a timer-responsive devices for providing a visual signal and/or audible signal to a person using the dice at one or more preselected times.

### BACKGROUND OF THE INVENTION

Conventional playing dice for games and the like comprise one or more cubes or polygons with appropriate numbers, symbols or dots representing a game instruction on the sides of the dice. In playing many games, such as board games, one or more dice are thrown by each player to determine the number of steps to take on the board game or to determine other action on the part of the player. In playing the game, the player may be required to press or otherwise manually activate a timer device that is separate form the board game and the dice. The timer determines the time within which the player must complete a move or take some other action in playing the game.

### SUMMARY OF THE INVENTION

The present invention provides a die for use in playing a game wherein the die includes a die body on or inside of which are disposed an electronic timer, at least one of a visual signal generating device and audible signal generating device which are activated in response to time signals of the electronic timer, and a motion sensing device for activating the timer to start timing when the die is rolled during use in playing a game. The electronic timer, at least one visual signal generating device and audible signal generating device, and motion sensing device preferably are disposed in a chamber inside of a hollow die body.

In an illustrative embodiment of the invention, the die comprises a hollow die body, such as hollow cube, having an electronic timer and battery in a chamber inside the die body to power the timer. A motion sensing device in a chamber inside the die body senses rolling of the die on a surface and activates the electronic timer to start timing for preselected time intervals. The hollow die body includes one or more light-emitting devices mounted on one or more sides of the die body or in a chamber inside the hollow die body to provide a light signal to the player after one or more preselected time periods elapse as controlled by a control and timer device. When the light emitting device is disposed inside the hollow die body, the die body or regions thereof can be transparent or translucent so that the light is transmitted through one or more walls of the body. The hollow die body also includes a timer-responsive audible sound-generating device, such as for example a buzzer, in a chamber inside the die body to provide a sound signal to the player after one or more time periods elapse as controlled by the control and timer device. The hollow die body may include one or more apertures in one or more sides of the die body through which the audible sound signal can be travel. One or more of the above components can be mounted on a circuit board within the hollow die body.

The invention is described in more detail in connection with the following drawings taken with following detailed description.

### DESCRIPTION OF THE DRAWINGS

FIGS. 1, 2, and 3 are perspective schematic views taken at different angles of a die in accordance with an illustrative embodiment of the invention wherein certain internal components are not shown in all of the figures. The die body is illustrated as being transparent plastic matieral so as to see the internal components, which are shown with solid lines for convenience, although they would typically be shown using hidden lines.

FIG. 4 is a schematic view of the die body with the front side omitted to show internal features of a die in accordance with another illustrative embodiment of the invention. The motion sensor 54 is shown out of position in front of the batteries 26 for convenience in showing the internal components of the die.

FIG. 5 is a schematic electrical diagram showing the electronic control and timer chip device, motion sensor, light emitting diodes, buzzer and battery located in an internal chamber of the die.

FIGS. 6 and 7 illustrate typical indicia labels which can be provided on the exterior sides or faces of the die.

FIG. 8 is a perspective view of an assembled die pursuant to another embodiment of the invention.

FIG. 9 is an exploded perspective view of the die of FIG. 8.

FIG. 10 is an elevational view of internal components of the die.

FIG. 11 is a bottom view of FIG. 10 showing the battery compartment.

### DESCRIPTION OF THE INVENTION

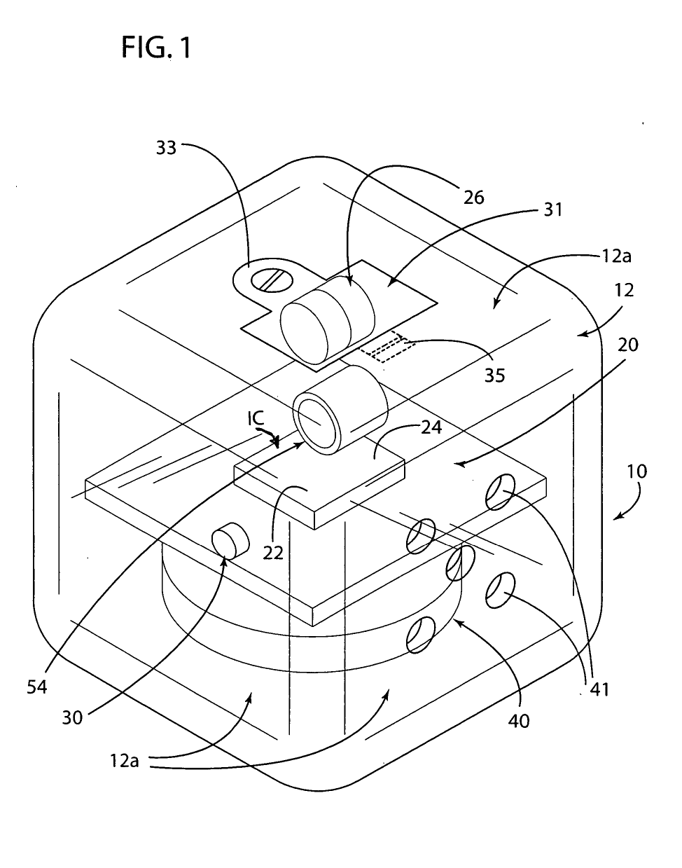

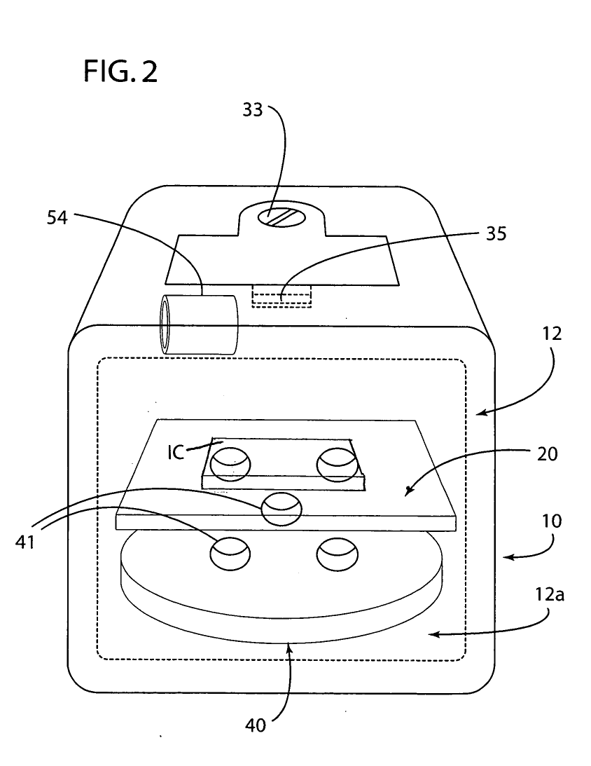

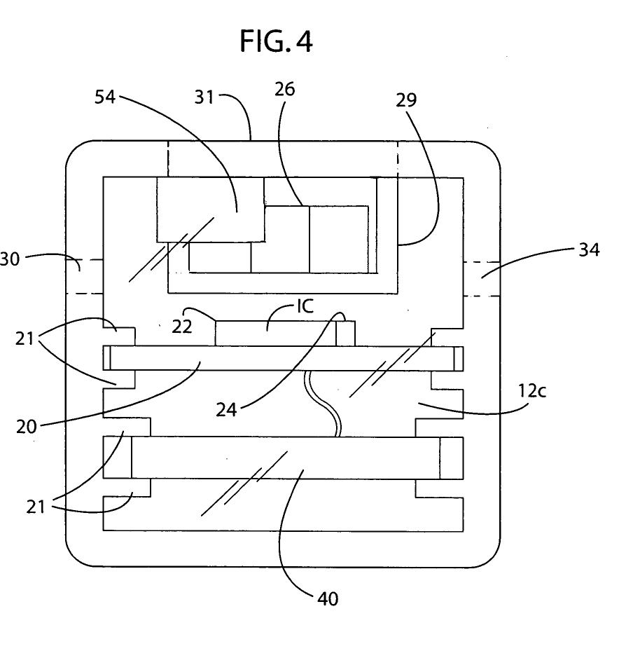

Referring to FIGS. 1-3, a die 10 for use in playing a game is schematically shown for purposes of illustration and not limitation as comprising a hollow, six-sided cube-shaped die body 12, which typically is made of a plastic material although the die can be made of any other suitable material. The invention is not limited to a cube-shaped die body 12 since the die body can be any polygonal shape having multiple faces or sides 12a, which may be flat or arcuate. The six sides or faces of the cube-shaped die body can have indicia thereon which can include numbers, dots, written messages, and the like. FIGS. 6 and 7 illustrate typical written messages which can be applied as labels on the sides or faces 12a of the cube-shaped die body 12. The labels attached to the cube faces or sides 12a are shown in unfolded condition to show all faces of the labels. Typical indicia can include those indicia present on a traditional gaming die or play instructions such as lose a turn, pick a card, or replace a word. The faces or sides 12a also may have colors or shaped images to indicate game actions to take. The indicia can be applied to the faces or sides by painting, molding, hot stamp, tampo printing, overlays of paper, labels, and the like. The indicia can be provided on the exterior surfaces or on the interior surfaces of the faces or sides 12a in the event the cube is made of transparent material. FIG. 4 shows the internal features of a similar die 10 pursuant to a slightly different embodiment of the invention.

The die body 12 defines via its sides 12a an internal chamber 12c, FIG. 4 of a similar embodiment, and has an electronic timer located on the die body, such as in the chamber 12c inside the die body. At least one of a timer-responsive visual signal generating device and audible signal generating device is/are located on the die body 12. For example, referring to FIGS. 1-4 for illustrative embodiments of the invention, a circuit board 20 is shown disposed or mounted in the internal chamber 12c inside the die body 12 and has mounted thereon a control and timer device 22, such as a conventional integrated circuit (IC) control and timer chip or other unit, that includes an electronic timer schematically designated 24. The control and timer device 22 can comprise a commercially available SONIX IC microcomputer chip that generates and processes time signals. The circuit board 20 can be mounted on the interior of the faces or sides of the die body using adhesive, using bosses 21, FIG. 4, molded on the interior of sides or faces 12a to receive and hold the circuit board, using clips on the faces or sides 12a, or any other suitable connection technique.

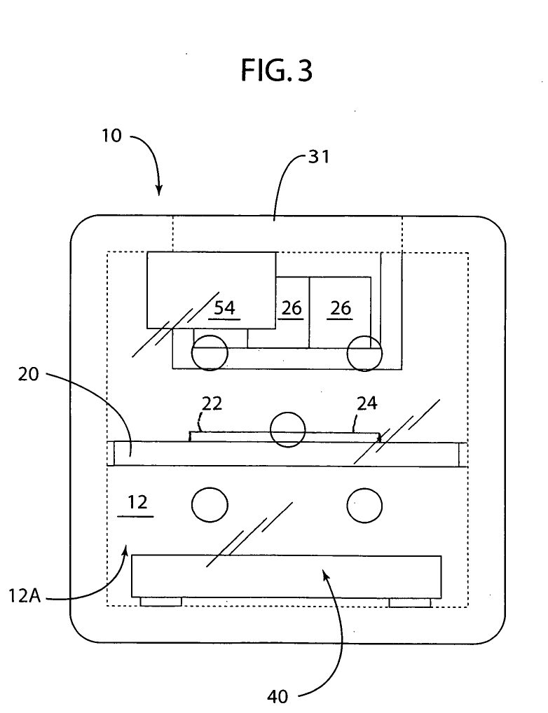

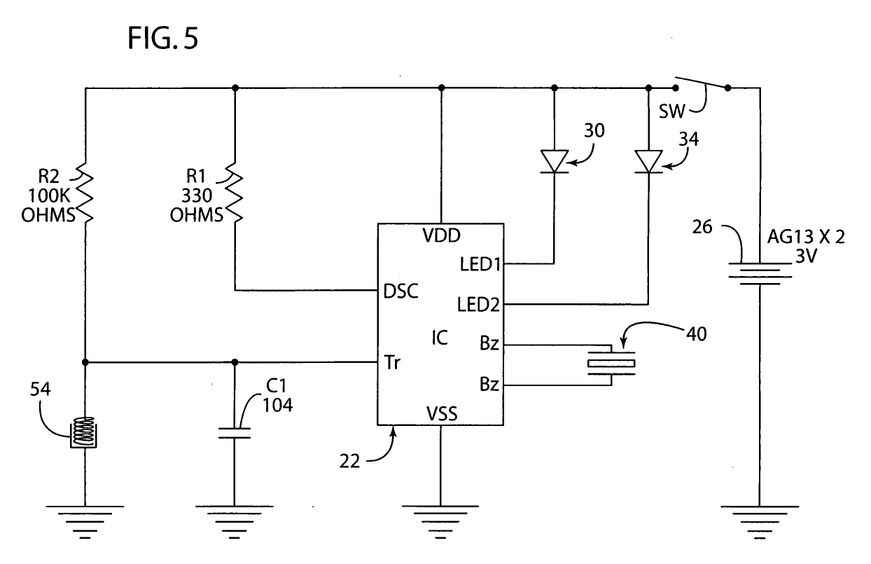

The control and timer device 22 is connected in an electronic circuit shown in FIG. 5 pursuant to an illustrative embodiment of the invention. For example, the control and timer chip or device 22 is electrically connected at chip terminal VDD by lead wires or conductors to a battery 26, which may comprise one or more conventional 3V batteries used to power the microcomputer, at chip terminal DSC to resistor R₁, and at chip terminal VSC to ground. The control and timer device 22 is also connected at respective chip terminals LED1 and LED2 as shown in FIG. 5 to first and second light-emitting diodes 30, 34 (as visual signal generating devices) to activate the LED's 30, 34 in response to time signals received from the electronic timer 24. The LED's 30, 34 are disposed on different sides or faces 12a of the die body, FIG. 4, such that one of the LED's 30 or 34 is always exposed for viewing by the game player regardless of the face or side 12a on which the die body 12 rests after being rolled. The LED's each can comprise 3 mm diameter red LED's for purposes of illustration and not limitation. For example, the LED's 30, 34 can be disposed (e.g. adhered in apertures) on opposite faces or sides 12a to this end. One or more LED's can be disposed on each face or side 12a in arrays to provide further indicia thereon. In an alternate embodiment of the invention, FIGS. 8-11, the LED's 30, 34 can be disposed in the internal chamber 12c inside the die body 12 that is transparent, translucent or otherwise light conductive at one or more regions so that the light emitted can pass through regions of the die body. The invention is not limited to use of LED's as the visual signal generating devices since other devices can be employed to this end, such as for example liquid crystal displays, electrochromic displays, and others disposed on side walls of the die body or in an internal chamber inside the die body.

The battery 26 is mounted in a battery box or holder 29 that can be formed integrally with and inside the die body 12 or formed integrally on a battery cover 31 attached to the die body. The battery 26 is accessible via a battery cover 31 releasably attached in a molded opening in the face or side 12a of the die body 12. The cover 31 is fastened to be substantially flush with the exterior face or side of the die body 12. The cover 31 is fastened to die body 12 by a screw 33 and integral cover tongue 35 snap-fit or frictionally engaged in a molded groove or in an undercut of the die body. Only some of the wiring for the internal die components is shown in FIGS. 1-4 since a circuit diagram is shown in FIG. 5 for the internal components.

The chip or device 22 is also connected at respective chip terminals BZ as shown in FIG. 5 to an audible sound generating buzzer device 40 (or other audible signal generating device) to activate the buzzer in response to time signals of the electronic timer 24. The buzzer device 40 is illustrated as being disposed or mounted in the internal chamber 12c inside the die body below the circuit board 20 as shown in FIGS. 1-3 and 4. The buzzer device 40 can be mounted in the chamber 12c of the die body 12 using similar mounting techniques as is/are used to mount the circuit board 20 therein. For purposes of illustration and not limitation, the buzzer 40 can comprise a commercially available (IRON) 27 mm conventional buzzer device. One or more of the faces or sides 12a of the die body includes one or more apertures 41, FIG. 2, through which the audible buzzer sound signal can be travel for hearing by the game player.

The chip or device 22 is also connected at chip terminal Tr as shown in FIG. 5 to resistor R₂, capacitor C₁, and a motion sensing device 54 that, for purposes of illustration and not limitation, comprises a conventional 4 mm diameter spring type motion trigger sensor, although the invention can be practiced using other types of motion sensors. The motion sensing device 54 can be disposed or mounted on the die body 12, or on the circuit board 20 or on another internal component in the internal chamber 12c inside of the die. The motion sensing device 54 senses rolling of the die 10 and is provided in the die body 12 for activating the electronic timer 24 to start its timing function when the die 10 is rolled by the player on the game board, table surface, floor, or other playing surface during playing of the game.

A master switch SW, FIG. 5, in the form of pushbutton switch, slide switch or other switch can be provided on the die body 12 and connected electrically between the battery 26 and the chip or device 22 to control energization of the die 10 for playing a game. When the die is not being used, the master switch would be activated to disconnect the battery 26 from supplying power to the chip or device 22.

The die body 12 may be conventionally injection molded in multiple parts that are joined together by adhesive, sonic welding or other fastening techniques to facilitate assembly of the internal components. The battery cover 31 may be secured with an undercut in the die body 12 and with a screw 33 to permit changing of the batteries.

The invention thereby provides a game die 10 having lights and/or sounds to indicate when a player's turn begins and is complete. For purposes of illustration and not limitation, the die 10 is activated by rolling it (e.g. by impact and/or by tumbling) on the game board or other surface as a result of the motion sensing device 54 activating the electronic timer 24. Upon activation, the timer 24 begins its timing function, and the LED's 30, 34 may be illuminated or flashed under control of chip or device 22 in response to activation of the electronic timer to indicate visually to the player that the timer is counting down. The player may be notified by a warning sound from buzzer device 40 and by illuminated or flashing LED's 30, 34 under control of chip or device 22 in response to further time signals received from the electronic timer as the turn is approaching to a close. A final buzzer sound and/or LED light is generated under control of the chip or device 22 in response to additional time signals to indicate to the player when the time to complete the turn is ended. The time period of the player's turn can be adjusted by appropriate programming of the chip or device 22 based on requirements or levels of the game. Moreover, a shorter time for a player's turn can be provided for adult players, while a longer time can be provided for children playing the game. Further, the chip or device 22 may be programmable and the sound generating device 40 selected of the type to generate simulated voice commands such as a number, a game playing instruction and the like.

Referring to FIGS. 8-11, another embodiment of a game die pursuant to the invention is illustrated where the die components are arranged or packaged in a different manner. In FIGS. 8-11, features which are alike or functionally equivalent to those of FIGS. 1-4 are given like reference numbers. In FIG. 8, the die 10 comprises an injection molded plastic cube-shaped die body 12 with rounded corners for purposes of illustration and not limitation. The faces or sides 12a of the die body have printed paper labels L glued thereto and containing written and numerical messages to the game players. One face or side of the die body 12 includes a circular opening 12o that receives certain internal components mounted on a circular-shaped molded plastic die body cover 12cs, although the opening and the cover can have any suitable shape other than circular. The cover 12cs is adapted to be snap fit in the opening 12o and/or adhered or welded or otherwise attached on the die body with the internal components thereby supported in the chamber 12c in the die body 12. The cover 12cs forms a part of the die body after attachment thereto.

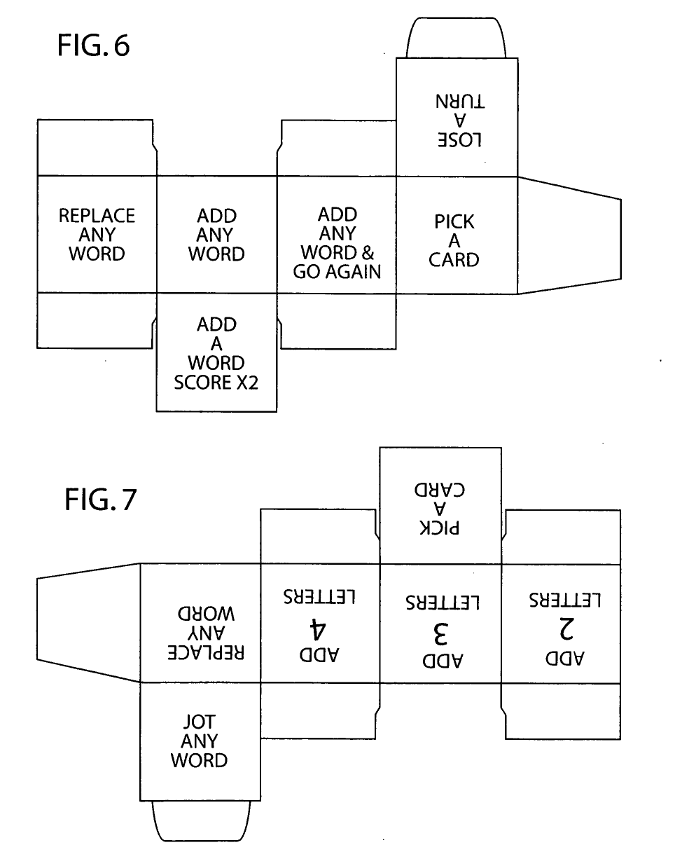

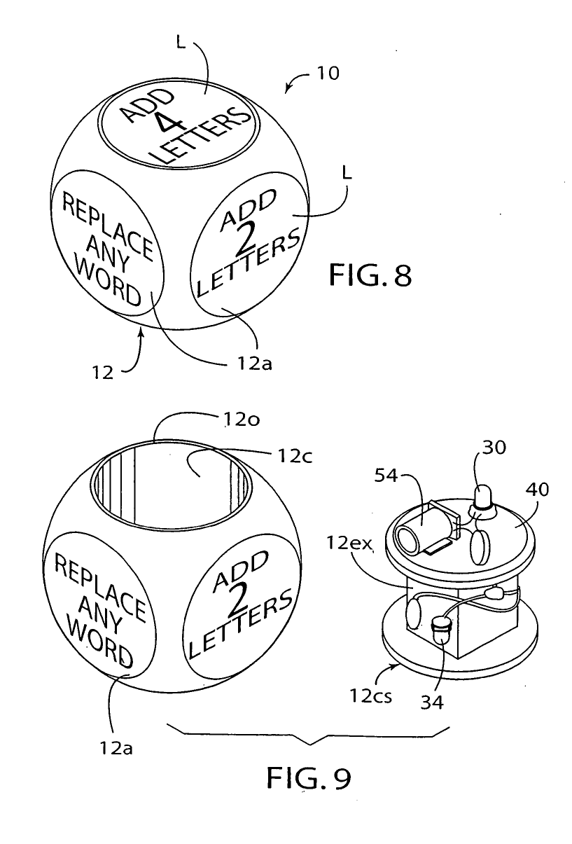

The cover 12cs includes a polygonal extension 12ex having flat exterior and interior sides, although the extension can have any suitable shape. The circuit board 20 carrying the control and timer chip or device 22 is mounted on a closed end of the extension 12ex perpendicular to its longitudinal axis. For purposes of illustration and not limitation, the circuit board 20 is glued, clipped or screwed on the end of the extension 12ex. The circuit board 20 includes electrical connection terminals 22t that are connected to chip terminals VSS, VDD, TR, BZ, LED1, LED2, etc.) and that are shown in FIG. 10 to which electrical connections can be made to form the circuitry of FIG. 5 using lead wires shown. The buzzer device 40 is disposed on the chip or device 22 and held thereon by glue, separate mechanical clips, clips molded on the die body or other fastening technique. The motion sensing device 54 as well as an LED light emitting device 30 are disposed on the buzzer device 40 as shown in FIGS. 9-10. The LED 30 can be mounted by glue on the top of the buzzer 40. Another LED light emitting device 34 is mounted by glue on a side of the extension 12ex. The light emitted by the light emitting devices 30, 34 can pass through the transparent or translucent plastic regions of the die body 12 not covered by the printed paper labels L.

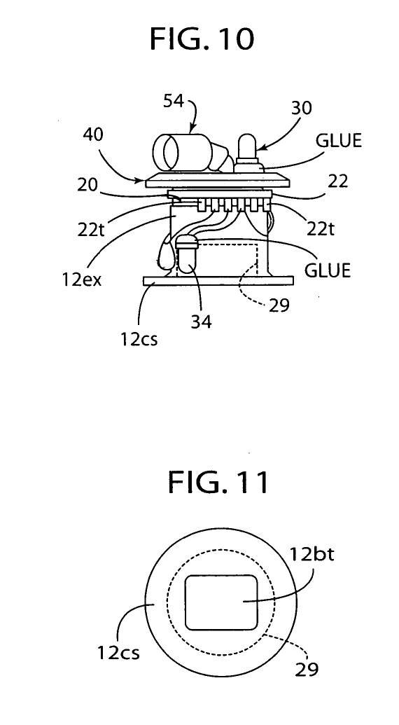

The extension 12ex is molded to define an interior battery box or compartment 29 for receiving the batteries (not shown) in FIG. 10-11. The cover 12cs includes a secondary battery cover 12bt that is snap fit on the cover 12cs to provide access to the batteries. Cover 12cs may have a label thereon, may be hot stamped with indicia, or otherwise provided with indicia. The function of the die 10 of FIGS. 8-11 in playing a game is the same as described above with respect to the die embodiment of FIGS. 1-5.

The die body 12 of FIG. 8-11 may be conventionally injection molded in multiple parts that are joined together by adhesive, sonic welding or other fastening techniques. Likewise, the cover 12cs and extension 12ex may be molded in multiple parts that are fastened together by adhesive, sonic welding or other fastening technique in assembly of the die 10. The battery cover 12bt may be separately molded and secured on the cover 12cs to permit changing of the batteries. When the cover 12cs is attached to the die body 12, the cover extension 12ex and the electronic components mounted thereon reside in the internal chamber 12c and on the die body 12.

Although the invention has been described above in connection with certain illustrative embodiments, those skilled in the art will appreciate that the invention is not limited to such embodiments and that it may be modified within the scope of the appended claims.

1. A die for use in playing a game, comprising a die body on or inside of which are disposed an electronic timer, at least one of a visual signal generating device and an audible signal generating device activated in response to time signals of the timer, and a motion sensing device for activating the timer to start timing when the die is used in playing the game.

2. The die body of claim 1 wherein said timer is disposed in a chamber inside the die body.

3. The die body of claim 1 wherein said at least one of said visual signal generating device and said audible signal generating device is disposed in a chamber inside the die body.

4. The die body of claim 1 wherein said motion sensing device is disposed in a chamber inside the die body.

5. The die of claim 1 including a control and timer device that includes said timer, said device controlling activation of said at least one of said visual signal generating device and said audible signal generating device in response to timing signals.

6. The die of claim 1 including a battery disposed inside the die body for energizing the electronic timer.

7. The die of claim 1 wherein said visual signal generating device includes a timer-responsive light-emitting devices disposed in a chamber inside the die body.

8. The die of claim 1 wherein said visual signal generating device includes a timer-responsive light-emitting devices disposed on one or more sides of the die body.

9. The die of claim 1 wherein the audible signal generating device comprises a buzzer.

10. The die of claim 1 including one or more apertures in one or more side walls of the die body through which apertures audible sound passes.

11. The die of claim 1 comprising a hollow body.

12. The die of claim 1 including a circuit board disposed in a chamber inside the die body and on which the electronic timer is disposed.

13. A die for use in playing a game, comprising a hollow die body, an electronic timer disposed inside the hollow die body, at least one of a visual signal generating device disposed on or inside the hollow die body and an audible signal generating device disposed inside the hollow die body and activated in response to time signals of the timer, and a motion sensing device disposed inside the hollow die body for activating the timer to start timing when the die is used in playing the game.

14. A die for use in playing a game, comprising a hollow die body, a light-emitting device disposed on or in a chamber inside the die body, an audible sound generating device disposed in a chamber inside the die body, a motion sensing device disposed in a chamber inside the die body for activating the timer to start timing when the die is used in playing the game, a control and timer device disposed in a chamber inside the die body for controlling activation of the light-emitting device and the audible sound generating device in response to timing signals, and a battery disposed in a chamber inside the die body.

15. The die of claim 9 including a circuit board disposed in a chamber inside the die body and on which the control and timer device is disposed.
